(19) United States
(12) Patent Application Publication
(10) Pub. No.: US 2025/0358375 A1
(43) Pub. Date: Nov. 20, 2025

(54) INFORMATION PROCESSING APPARATUS, METHOD, AND NON-TRANSITORY COMPUTER-READABLE STORAGE MEDIUM

(71) Applicant: CANON KABUSHIKI KAISHA, Tokyo (JP)

(72) Inventor: TAKAFUMI MIZUNO, Tokyo (JP)

(21) Appl. No.: 19/210,770

(22) Filed: May 16, 2025

(30) Foreign Application Priority Data
May 20, 2024 (JP) 2024-081634

(51) Int. Cl. H04N 1/00; H04N 1/32

(52) U.S. Cl. CPC H04N 1/00395; H04N 1/00244; H04N 1/00315; H04N 1/32106; H04N 2201/0094

(57) ABSTRACT

An information processing apparatus includes one or more memories storing instructions, and one or more processors capable of executing the instructions causing the information processing apparatus to establish a communication connection to an image processing apparatus located in proximity to the information processing apparatus, activate a function for receiving scanned data from the image processing apparatus upon establishment of the communication connection to the image processing apparatus, and receive scanned data obtained by scanning a document on the image processing apparatus from the image processing apparatus using the function.

### BACKGROUND

### Field of the Disclosure

The present disclosure relates to a technique for processing scanned data obtained by scanning a document.

### Description of the Related Art

Conventionally, in a case where a user uses a multi-function peripheral (MFP), a main use case is to use a specific MFP located near the user's desk in the office of the user.

In recent years, with an increase in distributed work, the workplace has been changed from a company's office to a diversified form including a coworking space and a shared office where an office environment is shared. In offices, mobile terminals such as laptop personal computers (PCs) and tablet terminals have been used, and free addresses have become popular. Thus, an operation with users working at fixed desks in mind has changed.

Under such circumstances, occasions for a user to use an MFP that the user uses for the first time instead the MFP located near the user's desk in the office of the user has been increasing.

Japanese Patent Application Laid-Open No. 2023-030444 discusses a technique for setting address information (including a server Uniform Resource Locator (URL) and authentication information) about a server to which scanned data is transmitted from a client terminal when push scanning is executed by an MFP, and issuing a push scanning instruction including the address information to the MFP.

In the case of executing push scanning to a mobile terminal of the user from an MFP that the user uses for the first time in a coworking space or a shared office, for example, using the related-art technique, the user needs to perform an operation that requires technical knowledge about servers, networks, and the like.

For example, on the mobile terminal of the user, the user makes server settings to receive data from an MFP and also makes a network connection setting between the mobile terminal and the MFP. Further, the user needs to perform an operation to make settings such as an Internet Protocol (IP) address of the mobile terminal and transmission settings for a communication protocol or the like in the MFP to transmit scanned data to the mobile terminal from the MFP.

The technical knowledge about servers, networks, and the like is required to make these settings. However, in most cases, a general user who simply uses a MFP does not have the technical knowledge. Therefore, it is difficult for such a general user to load data into a mobile terminal of the user by scanning a document in such an environment. Even if the user has the technical knowledge, the operation of making settings for the mobile terminal and the MFP is troublesome for the user.

### SUMMARY

According to an aspect of the present disclosure, an information processing apparatus includes one or more memories storing instructions, and one or more processors capable of executing the instructions causing the information processing apparatus to establish a communication connection to an image processing apparatus located in proximity to the information processing apparatus, activate a function for receiving scanned data from the image processing apparatus upon establishment of the communication connection to the image processing apparatus, and receive scanned data obtained by scanning a document on the image processing apparatus from the image processing apparatus using the function.

Further features of various embodiments will become apparent from the following description of exemplary embodiments with reference to the attached drawings.

### BRIEF DESCRIPTION OF THE DRAWINGS

FIG. 1 is a block diagram illustrating an example of a system configuration according to a first exemplary embodiment of the present disclosure.

FIG. 2 is a block diagram illustrating an example of a detailed configuration of a controller unit of a multi-function peripheral (MFP).

FIG. 3 is a block diagram illustrating an example of a detailed configuration of a client terminal.

FIG. 4 is a block diagram illustrating an example of a software configuration of the MFP.

FIG. 5 is a block diagram illustrating an example of a software configuration of the client terminal.

FIG. 6 is a diagram illustrating an example of a sequence for executing scanning according to the first exemplary embodiment.

FIGS. 7A, 7B, 7C, 7D, 7E, and 7F each illustrate an example of a screen to be displayed on the client terminal according to the first exemplary embodiment.

FIGS. 8A, 8B, 8C, 8D, and 8E each illustrate an example of a screen to be displayed on the MFP according to the first exemplary embodiment.

FIG. 9 is a flowchart illustrating an example of processing to be performed by the client terminal during easy scan processing according to the first exemplary embodiment.

FIGS. 10A and 10B are a flowchart illustrating an example of processing to be performed by the MFP during easy scan processing according to the first exemplary embodiment.

FIGS. 11A and 11B each illustrate an example of a screen to be displayed on a MFP according to a second exemplary embodiment.

FIGS. 12A and 12B are a flowchart illustrating an example of processing to be performed by the MFP during easy scan processing according to the second exemplary embodiment.

FIGS. 13A and 13B are a flowchart illustrating an example of processing to be performed by the client terminal during easy scan processing according to the second exemplary embodiment.

FIG. 14 illustrates an example of a screen to be displayed on the client terminal according to the second exemplary embodiment.

### DESCRIPTION OF THE EMBODIMENTS

Hereinafter, exemplary embodiments of the present disclosure will be described with reference to the drawings. However, all the features described in the exemplary embodiments are not necessarily essential to the solving means of the present disclosure. In the exemplary embodiments of the present disclosure, an example in which an image forming apparatus and a client terminal operate in conjunction with each other will be described.

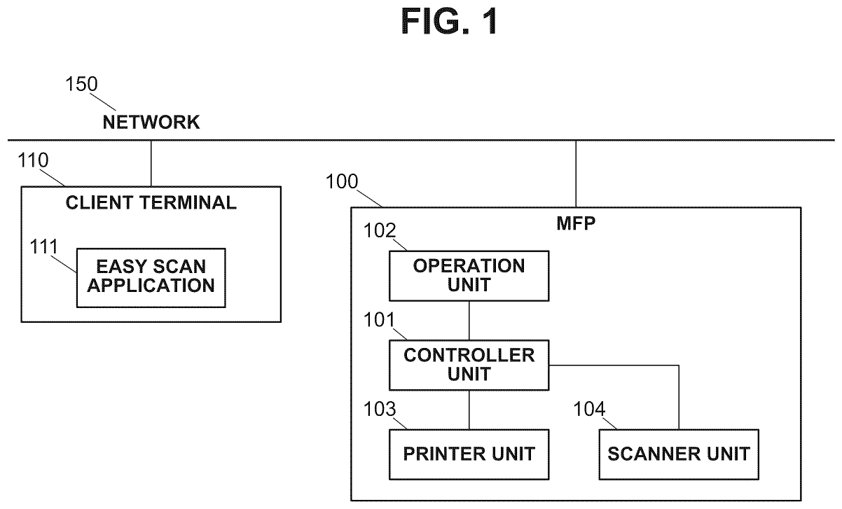

FIG. 1 is a block diagram illustrating an example of a system configuration according to a first exemplary embodiment of the present disclosure.

The system according to the first exemplary embodiment includes a multi-function peripheral (MFP) 100 and a client terminal 110. The MFP 100 and the client terminal 110 are communicably connected via a network 150. In the first exemplary embodiment, the network 150 is a wireless connection network.

The MFP 100 is an image processing apparatus such as a multifunction apparatus. The MFP 100 has functions of scanning images, printing images using a printer, and performing facsimile (fax) transmission and reception. The MFP 100 includes an operation unit 102 that performs input and output with a user. The MFP 100 includes a printer unit 103 (a printer) that outputs electronic data to a paper medium. The MFP 100 includes a scanner unit 104 (a scanner) that scans a paper medium and converts scanned data into electronic data. The operation unit 102, the printer unit 103, and the scanner unit 104 are each connected to a controller unit 101 and implement the functions as a multifunction apparatus under the control of the controller unit 101. Alternatively, the MFP 100 may not include the printer unit 103.

The client terminal 110 is an information processing apparatus including an application program (hereinafter referred to as an “application”) such as an easy scan application 111, an operating system (OS) (not illustrated), and various drivers. The client terminal 110 may include various applications such as a document creation application and a spreadsheet application (not illustrated).

The easy scan application 111 connects to the MFP 100, starts a file server included in the MFP 100, and receives electronic data obtained through scanning by the MFP 100 using the file server.

Examples of the client terminal 110 include a laptop personal computer (PC), a tablet terminal, and a smartphone. FIG. 1 illustrates only components used to describe the present exemplary embodiment. The client terminal 110 may also include a component other than the components illustrated in FIG. 1 as long as the present disclosure can be carried out. The connection configuration between the components is not limited to that illustrated in FIG. 1.

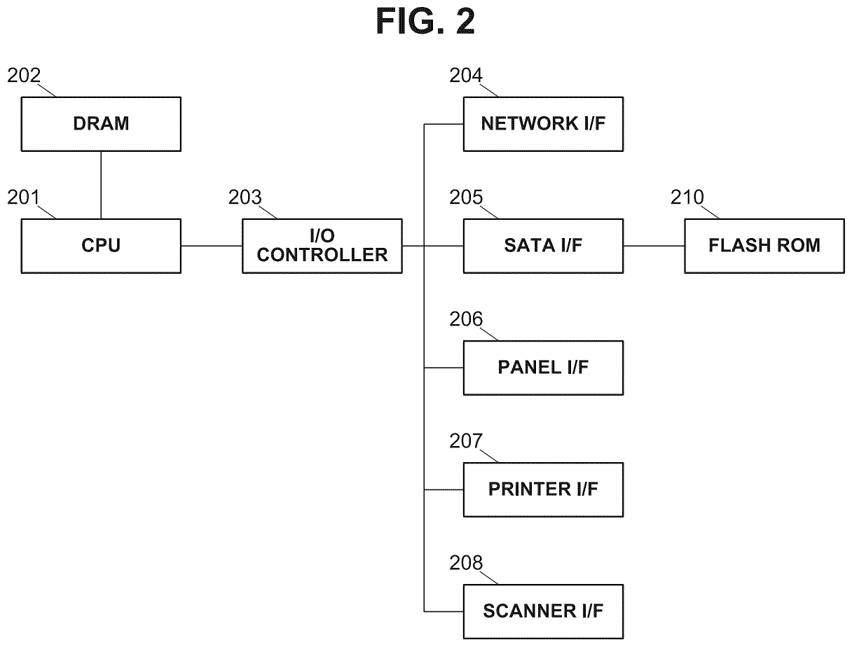

FIG. 2 is a block diagram illustrating an example of a detailed configuration of the controller unit 101 of the MFP 100.

A central processing unit (CPU) 201 performs main arithmetic processing in the controller unit 101. The CPU 201 is connected to a dynamic random access memory (DRAM) 202 via a bus. The DRAM 202 is used by the CPU 201 as a work memory for temporarily arranging program data indicating operation instructions in the process of arithmetic operation by the CPU 201 and data to be processed.

The CPU 201 is also connected to an input/output (I/O) controller 203 via a bus. The I/O controller 203 performs input to and output from various devices according to an instruction from the CPU 201.

The I/O controller 203 is connected to a Serial Advanced Technology Attachment (SATA) interface (I/F) 205, and a flash read-only memory (ROM) 210 is connected to the SATA I/F 205. The CPU 201 uses the flash ROM 210 to persistently store programs for implementing the functions of the MFP 100 and document files. Instead of the flash ROM 210, another storage device such as a hard disk drive (HDD) may be connected, or such a storage device may be used together.

The I/O controller 203 is also connected to a network I/F 204. The network I/F 204 is connected to a wired local area network (LAN) device or a wireless LAN device. The CPU 201 controls the wired LAN device or the wireless LAN device via the network I/F 204, thereby implementing communication on the network 150.

The I/O controller 203 is also connected to a panel I/F 206. The CPU 201 implements input and output for the user on the operation unit 102 via the panel I/F 206.

The I/O controller 203 is also connected to a printer I/F 207. The CPU 201 implements paper medium output processing using the printer unit 103 via the printer I/F 207.

The I/O controller 203 is also connected to a scanner I/F 208. The CPU 201 implements processing for scanning an image from a document using the scanner unit 104 via the scanner I/F 208.

The MFP 100 includes various applications for using the functions of the MFP 100. Examples of the applications include applications that support a copy function, a transmission function, a fax function, and a box function. The CPU 201 loads program data corresponding to these functions from the flash ROM 210 into the DRAM 202 via the SATA I/F 205 and executes the program data to thereby implement these functions.

In the case of implementing the copy function, the CPU 201 detects a copy instruction from the user on the operation unit 102 via the panel I/F 206 according to the program data loaded into the DRAM 202. Upon detecting the copy instruction, the CPU 201 receives a document image from the scanner unit 104 via the scanner I/F 208 as electronic data and stores the electronic data in the DRAM 202. The CPU 201 performs color conversion processing or the like suitable for an output on image data stored in the DRAM 202. The CPU 201 transfers the image data stored in the DRAM 202 to the printer unit 103 via the printer I/F 207, and performs output processing on a paper medium.

In the case of implementing the transmission function, processing in which the CPU 201 detects a transmission instruction from the user is similar to the processing for the copy function described above. The transmission instruction includes a transmission protocol, a transmission destination, and an image format, which are designated by the user. The transmission protocol is, for example, a server message block (SMB) or a file transfer protocol (FTP). The transmission destination is designated by, for example, Universal Naming Convention (UNC). Examples of the image format include Joint Photographic Experts Group (JPEG) and portable document format (PDF). Upon detecting the transmission instruction, the CPU 201 receives a document image from the scanner unit 104 via the scanner I/F 208 as electronic data and stores the electronic data in the DRAM 202. The CPU 201 performs, for example, a conversion into an image format designated by the user on the image data stored in the DRAM 202. The CPU 201 transfers the image data stored in the DRAM 202 to the transmission destination via the network I/F 204 using the protocol designated by the user.

In the case of implementing the fax function, processing in which the CPU 201 detects a fax instruction from the user is similar to the processing for the copy function described above. Upon detecting the fax instruction, the CPU 201 receives a document image from the scanner unit 104 via the scanner I/F 208 as electronic data and stores the electronic data in the DRAM 202. The CPU 201 performs, for example, a conversion into an image format for fax on the image data stored in the DRAM 202. The CPU 201 transfers the image data stored in the DRAM 202 to a telephone number for fax or the like designated in the fax instruction via a telephone network or the like connected to a fax I/F (not illustrated). Fax using a telephone line is merely an example, and fax via the Internet may also be used.

The box function is a function of storing scanned images in a storage area in the MFP 100 and a memory medium connected to the MFP 100, and releasing the images stored in the MFP 100 to an external PC or another MFP (not illustrated) when the MFP 100 functions as a file server. In the case of implementing the box function, processing in which the CPU 201 detects a box storage instruction from the user is similar to the processing for the copy function described above. The box storage instruction includes a storage destination and an image format, which are designated by the user. The storage destination is a path to the storage in the MFP 100 or a path to the memory medium connected to the MFP 100. Examples of the image format include JPEG and PDF. Upon detecting the box storage instruction, the CPU 201 receives a document image from the scanner unit 104 via the scanner I/F 208 as electronic data and stores the electronic data in the DRAM 202. The CPU 201 performs, for example, a conversion into an image format designated by the user on the image data stored in the DRAM 202. The CPU 201 transfers the image data stored in the DRAM 202 to the storage destination designated by the user, such as the flash ROM 210 in the MFP 100 or the memory medium (not illustrated), via the SATA I/F 205.

In the fax function, instead of printing out a received image, the received image may be converted into a format that can be viewed on a PC or the like and may be stored in a box. As the box function, the MFP 100 functions as a file server such as an SMB server and releases the contents of the flash ROM 210. In the box function, the CPU 201 detects a box access instruction from the outside via the network I/F 204. The box access instruction includes an image file path that is an access destination. The CPU 201 transfers the image data stored in the flash ROM 210 corresponding to the designated image file path to a requester of the box access instruction via the network I/F 204.

The above-described functions are merely examples of the functions of the MFP 100, and the MFP 100 may also include another function.

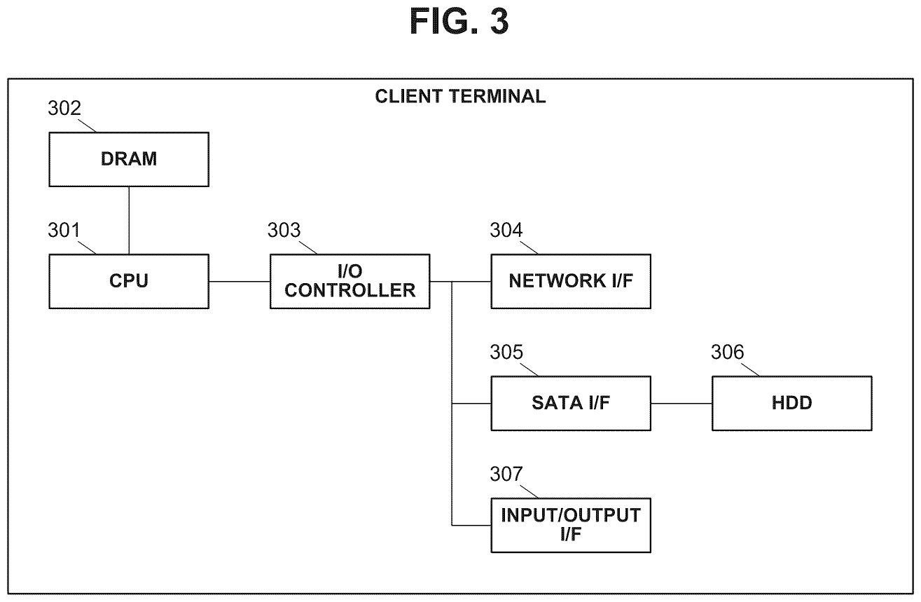

FIG. 3 is a block diagram illustrating an example of a detailed configuration of the client terminal 110.

A CPU 301 is connected to a DRAM 302 via a bus. The DRAM 302 is used by the CPU 301 as a work memory for temporarily arranging program data indicating operation instructions in the process of arithmetic operation by the CPU 301 and data to be processed.

The CPU 301 is connected to an I/O controller 303 via a bus.

The I/O controller 303 is connected to a network I/F 304. The network I/F 304 is connected to a wired LAN device, a wireless LAN device, or a data communication device. The CPU 301 controls the wired LAN device, the wireless LAN device, or the data communication device via the network I/F 304, thereby implementing communication on the network 150.

The I/O controller 303 performs input and output to and from various devices according to an instruction from the CPU 301.

The I/O controller 303 is also connected to a SATA I/F 305, and an HDD 306 is connected to the SATA I/F 305. Instead of the HDD 306, another storage device such as a solid state drive (SSD) or an embedded MultiMediaCard (eMMC) may be connected, or such a storage device may be used together. The CPU 301 uses the HDD 306 to persistently store setting values for programs such as the easy scan application 111, and the like.

The I/O controller 303 is also connected to an input/output I/F 307. The CPU 301 implements input and output for the user on an input/output device of the client terminal 110 connected via the input/output I/F 307. Examples of the input/output device include a touch panel that implements both input and output and that is connected to the input/output I/F 307, and an output device such as a display for performing display and an input device such as a keyboard for performing input that are each connected to the input/output I/F 307.

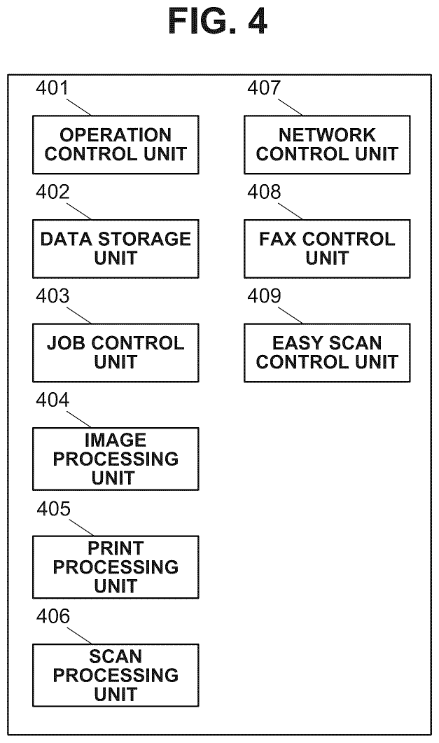

FIG. 4 is a block diagram illustrating an example of a software configuration to be executed by the controller unit 101 of the MFP 100. The software to be executed by the controller unit 101 is executed after the CPU 201 loads a program stored in the flash ROM 210 into the DRAM 202, to thereby implement, for example, functional units 401 to 409 illustrated in FIG. 4.

The operation control unit 401 executes processing for displaying a screen image for the user on the operation unit 102, and processing for detecting a user operation from the operation unit 102 and executing processing associated with a screen component such as a button displayed on a screen.

The data storage unit 402 stores a request from another control unit in the flash ROM 210 and loads the request from the other control unit from the flash ROM 210.

The job control unit 403 controls execution of a job according to an instruction from another control unit.

The image processing unit 404 processes image data into a format suitable for each use application according to an instruction from the job control unit 403.

The print processing unit 405 prints an image on a paper medium and outputs the paper medium via the printer I/F 207 according to an instruction from the job control unit 403.

The scan processing unit 406 scans a document that is set via the scanner I/F 208 according to an instruction from the job control unit 403.

The network control unit 407 inputs and outputs data from Wireless Fidelity (Wi-Fi®) or a public telephone network via the network I/F 204 according to an instruction from each control unit. Further, the network control unit 407 enables the data storage unit 402 to access data stored in the flash ROM 210 from an external device via the network control unit 407. Examples of data stored in the flash ROM 210 include images of PDF and JPEG format.

The fax control unit 408 performs processing for receiving fax data received from the network control unit 407 according to an instruction from the job control unit 403, issuing a print instruction to the print processing unit 405, and converting fax data into a PDF image or a JPEG image and storing the image into the data storage unit 402. Further, the fax control unit 408 transmits fax data via the network control unit 407 based on image data scanned by the scan processing unit 406.

The easy scan control unit 409 performs processing related to scanning with the client terminal 110. The easy scan control unit 409 is a control unit for implementing the processing performed in the MFP 100 to implement the function of the easy scan application 111 described above with reference to FIG. 1. The easy scan control unit 409 performs communication processing with the client terminal 110 using the network control unit 407. Further, the easy scan control unit 409 displays a scan execution screen and an error screen using the operation control unit 401. Further, the easy scan control unit 409 issues a scan instruction to the job control unit 403, executes scanning using the scan processing unit 406, and transmits scanned data stored in the data storage unit 402 to the client terminal 110 using the network control unit 407.

FIG. 5 is a block diagram illustrating an example of a software configuration of the client terminal 110.

Software including the easy scan application 111 to be executed by the client terminal 110 is executed after the CPU 301 loads a program stored in the HDD 306 into the DRAM 302, to thereby implement, for example, functional units 501 to 505 illustrated in FIG. 5.

The client operation control unit 501 executes processing for displaying a screen image for the user, and processing for detecting a user operation and executing processing associated with a screen component such as a button displayed on a screen.

The client data storage unit 502 stores electronic data, such as an image file, into the HDD 306 and loads the electronic data from the HDD 306.

The client network control unit 503 establishes network communication with an external apparatus.

The client FTP server control unit 504 executes an FTP server function in the client terminal 110, and exchanges data with the MFP 100 using the client network control unit 503.

The client easy scan control unit 505 provides the user of the client terminal 110 with an easy scan function (a function of the easy scan application 111) using the control units 501 to 504 described above.

The client terminal 110 is operated by an OS, and applications such as the easy scan application 111 run on the OS. The operation of the OS, however, is not essential for the present exemplary embodiment, and thus the description thereof is omitted.

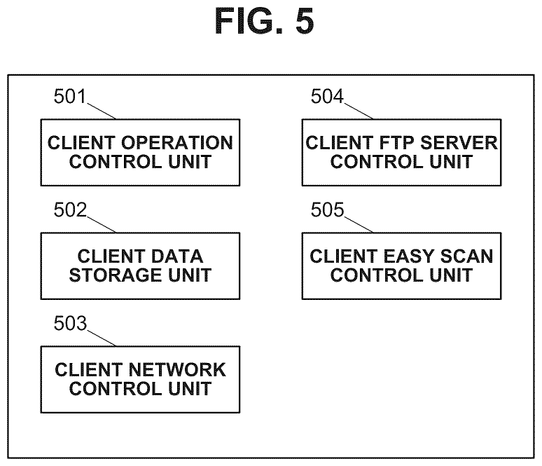

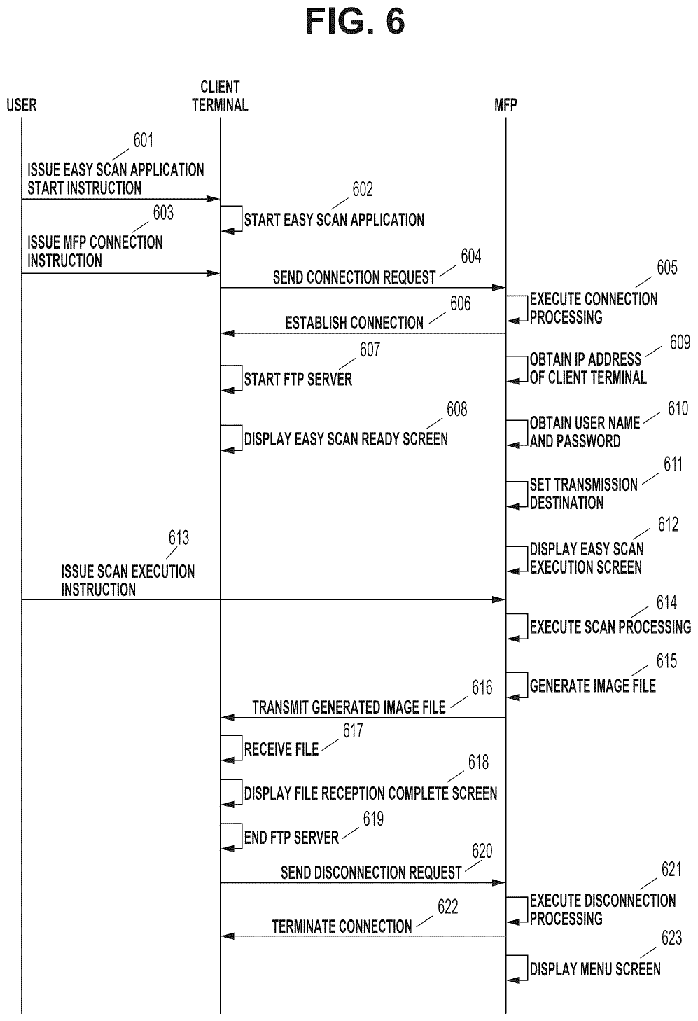

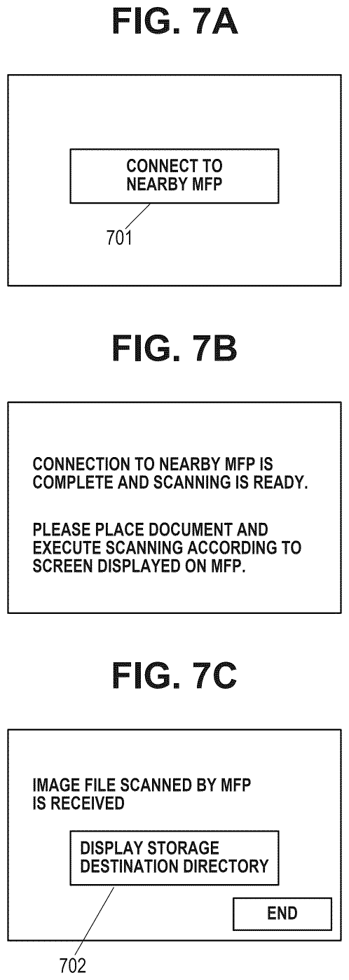

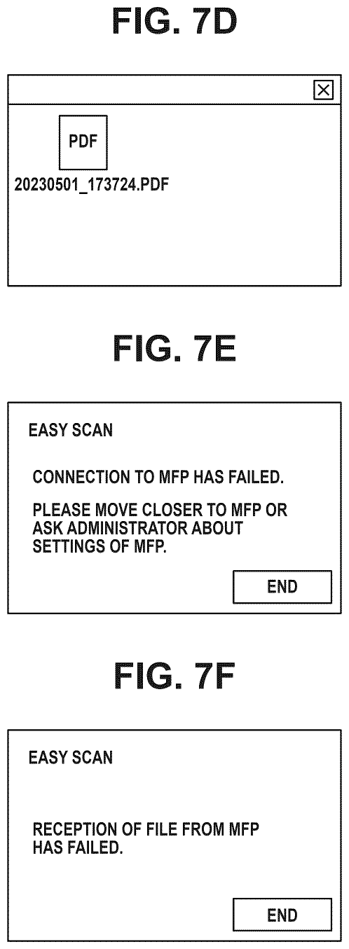

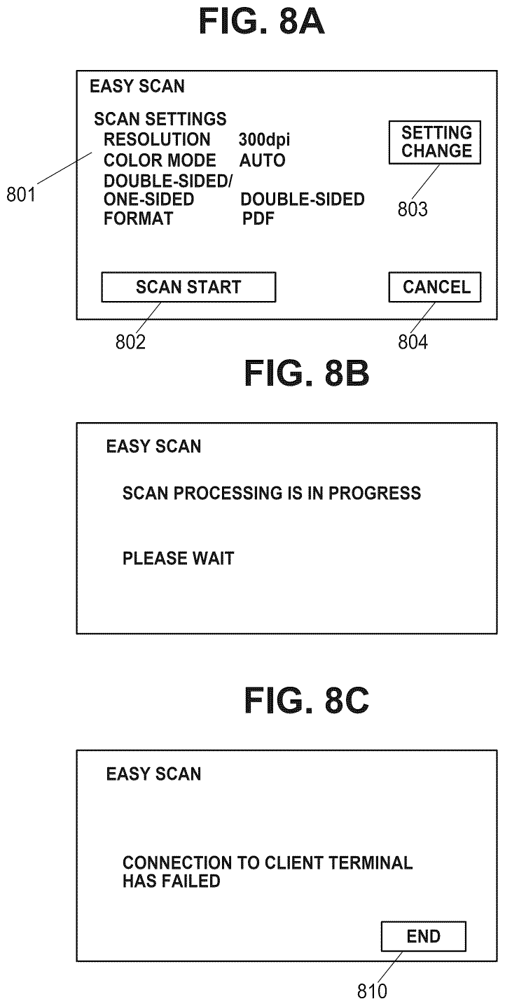

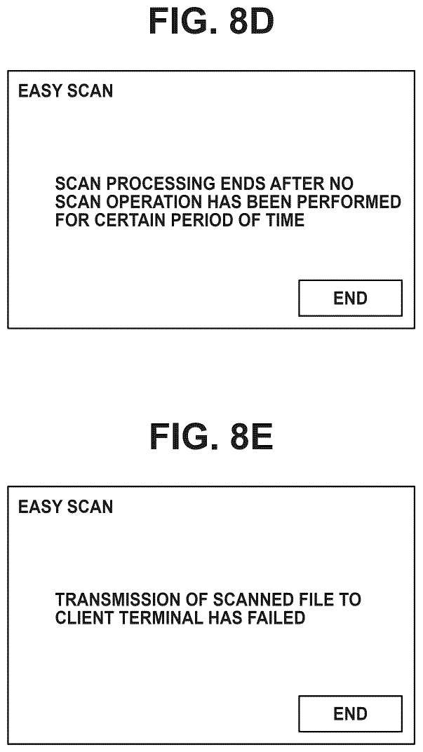

An outline of an operation according to the present exemplary embodiment will be described below with reference to FIG. 6, FIGS. 7A, 7B, 7C, 7D, 7E, and 7F, and FIGS. 8A, 8B, 8C, 8D, and 8E.

FIG. 6 is a diagram illustrating an example of a sequence in which the client terminal 110 connects to the MFP 100 and executes scanning. Processing performed by the client terminal 110 illustrated in FIG. 6 is executed by a function to be implemented when the CPU 301 loads a program stored in the HDD 306 into the DRAM 302 and executes the program. The processing performed by the MFP 100 is executed by functions to be implemented when the CPU 201 loads programs stored in the flash ROM 210 into the DRAM 202 and executes the programs.

FIGS. 7A, 7B, 7C, 7D, 7E, and 7F each illustrate an example of a screen to be displayed on the client terminal 110 according to the first exemplary embodiment.

FIGS. 8A, 8B, 8C, 8D, and 8E each illustrate an example of a screen to be displayed on the MFP 100 according to the first exemplary embodiment.

Hereinafter, FIGS. 7A, 7B, 7C, 7D, 7E, and 7F are collectively referred to as “FIG. 7”, and FIGS. 8A, 8B, 8C, 8D, and 8E are collectively referred to as “FIG. 8”.

In step 601, the user issues an easy scan application start instruction to the client terminal 110, and the client terminal 110 receives the easy scan application start instruction from the user.

Upon receiving the easy scan application start instruction, in step 602, the client terminal 110 starts the easy scan application 111. When the easy scan application 111 is started, a connection screen as illustrated in FIG. 7A is displayed on an output device connected to the input/output I/F 307 of the client terminal 110.

As illustrated in FIG. 7A, a connection button 701 for connecting to the MFP 100 that is located near the client terminal 110 is displayed on the connection screen.

In step 603, the user presses the connection button 701 to connect to the nearby MFP 100, and the client terminal 110 detects pressing of the connection button 701 and receives an instruction to connect to the nearby MFP 100. If there is a plurality of MFPs located in proximity to the client terminal 110, the user may select a MFP 100 to connect to from a list of the MFPs that are located in proximity to the client terminal 110.

Upon receiving the instruction to connect to the nearby MFP 100 from the user, in step 604, the client terminal 110 sends a connection request to the MFP 100 that is located in proximity to the client terminal 110.

Upon receiving the connection request from the client terminal 110, in step 605, the MFP 100 executes connection processing. As a result, in step 606, the MFP 100 and the client terminal 110 establish a network connection (communication connection). The network connection between the MFP 100 and the client terminal 110 in steps 604 to 606 is established using a known communication technology such as Wi-Fi Direct®. This connection is established by, for example, directly connecting the client terminal 110 and the MFP 100 using wireless communication. The connection may be established using not only Wi-Fi Direct®, but also another type of wireless communication such as Bluetooth®. Alternatively, this connection may be established using a wired LAN.

When the client terminal 110 establishes the network connection with the MFP 100, in step 607, the client terminal 110 starts a FTP server. While, in the present exemplary embodiment, an example where the FTP is used as a file transfer protocol for scanned electronic data between the MFP 100 and the client terminal 110 is described, the protocol is not limited to the FTP as long as the protocol can transmit a file. For example, Secure Shell (SSH) File Transfer Protocol or Secure File Transfer Protocol (SFTP), SMB, Web Distributed Authoring and Versioning (WebDAV), Hyper Text Transfer Protocol (HTTP), or the like may be used. Specifically, in step 607, a function for receiving scanned data from the MFP 100 is activated upon establishment of the communication connection to the MFP 100.

Next, in step 608, the client terminal 110 displays a scan ready screen as illustrated in FIG. 7B on the output device of the client terminal 110.

After the network connection is established in step 605 described above, in step 609, the MFP 100 obtains an Internet Protocol (IP) address of the connected client terminal 110. For example, an IP address set when the connection is established via Wi-Fi Direct® may be obtained.

In step 610, the MFP 100 obtains a user name and a password used for the FTP to transmit scanned electronic data. The user name and the password that are determined in advance in a fixed manner for the MFP 100 and the client terminal 110 may be used. Alternatively, unique values may be generated using a hash function common to the MFP 100 and the client terminal 110 using an allocated IP address, date and time, or the like. The IP address of the client terminal 110, the user name and the password described above, and the like may be transmitted to the MFP 100 from the client terminal 110 and may be received by the MFP 100.

In step 611, the MFP 100 sets the IP address obtained in step 609 described above and the user name and the password obtained in step 610 described above as a transmission destination of scanned electronic data.

The MFP 100 that has performed the processing in steps 609 to 611 described above is ready for execution of scanning. Thus, in step 612, the MFP 100 displays an easy scan execution screen as illustrated in FIG. 8A on the operation unit 102.

As illustrated in FIG. 8A, default scan settings 801 are displayed on the easy scan execution screen. In the example illustrated in FIG. 8A, a scan resolution of 300 dpi, automatic color setting, double-sided scanning, and a file format of PDF are set. The scan settings are not limited only to the default scan settings 801, and another setting can also be made. For example, image combining (a setting for dividing the area of a document that is larger than a platen glass into a plurality of areas to be scanned and combining the scanned areas into one image) may be made on the easy scan execution screen. While the present exemplary embodiment describes an example where an automatic document feeder (ADF) is used, a document may be placed on a platen glass to be scanned.

A setting change button 803 is a button for changing the scan settings. A scan start button 802 is a button for executing scanning. A cancel button 804 is a button to be pressed to cancel an easy scan. The cancel button 804 is a button for cancelling the easy scan, for example, in a case where a certain user has connected the client terminal 110 to the MFP 100 but has left the MFP 100 unused in a connected state and another user wants to use the MFP 100 for copying or the like.

In step 613, the user places a document on the MFP 100 and presses the scan start button 802 on the easy scan execution screen illustrated in FIG. 8A to issue an instruction to start scan execution. In response to this, the MFP 100 receives a scan start instruction from the user.

Alternatively, the easy scan execution screen may be displayed in step 612 described above immediately after the connection is established in step 606 described above. After that, the processing of steps 609 to 611 may be executed. In this case, the user can issue a scan start instruction immediately after the client terminal 110 and the MFP 100 have established the connection.

Upon receiving the scan start instruction, in step 614, the MFP 100 executes scan processing based on settings related to scanning in the scan settings 801 using, for example, the ADF to read a document. In the example illustrated in FIG. 6, the scan processing is executed with a scan resolution of 300 dpi, automatic color setting, and double-sided scanning. In this case, the MFP 100 displays a screen indicating that the scan processing is in progress (e.g. a screen illustrated in FIG. 8B) on the operation unit 102.

After completion of the scan processing executed in step 614 described above, in step 615, the MFP 100 generates an image file based on the file format in the scan settings 801. In the example illustrated in FIG. 6, a PDF file is generated. As a file name, a unique name may be generated based on a date and time when scanning is executed, or a name may be obtained from a result of optical character recognition (OCR).

Next, in step 616, the MFP 100 connects to the client terminal 110 via the FTP using the IP address, the user name, and the password set in step 611 described above, and transmits the file generated in step 615 described above to the client terminal 110. In this case, the generated file may be transmitted to a top directory in the FTP server of the client terminal 110. Alternatively, a directory for the date when scanning is executed may be generated, and the generated file may be transmitted to the directory for the date instead of the top directory in the FTP server, or the generated file may be transmitted to another directory. Authentication and file transmission using a file transfer protocol such as FTP are known techniques, and thus detailed descriptions thereof are omitted.

In step 617, the client terminal 110 performs reception processing for receiving the file from the MFP 100 via the FTP server.

After completion of the reception processing via the FTP server in step 617 described above, in step 618, the client terminal 110 displays a file reception complete screen as illustrated in FIG. 7C on the output device of the client terminal 110.

As illustrated in FIG. 7C, a storage destination directory display button 702 is displayed on the file reception complete screen. When the user presses the storage destination directory display button 702, the client terminal 110 displays a directory in which the scanned electronic data has been stored as illustrated in FIG. 7D.

In step 619, the client terminal 110 ends the FTP server started in step 607 described above. In other words, in step 619, the client terminal 110 deactivates the function for receiving scanned data from the MFP 100.

In step 620, the client terminal 110 sends a disconnection request to the MFP 100.

Upon receiving the disconnection request from the client terminal 110, in step 621, the MFP 100 executes Wi-Fi Direct® disconnection processing based on the disconnection request. In step 622, the MFP 100 terminates the network connection between the MFP 100 and the client terminal 110.

In step 623, the MFP 100 displays a menu screen (not illustrated) for executing a copy, a fax, and the like on the operation unit 102, and ends the easy scan processing.

As described above, the user can easily perform push scanning from the MFP 100 to the PC of the user only by issuing the easy scan application start instruction in step 601, issuing the MFP connection instruction in step 603, and setting a document and issuing the scan execution instruction in step 613. After completion of scanning, the connection to the MFP 100 is also automatically disconnected. This prevents the user from being left connected to the MFP 100 in a case where the user forgets to perform a disconnection operation from the MFP 100.

When the easy scan application 111 is started, the easy scan application 111 may automatically start connecting to a nearby MFP without the user issuing the MFP connection instruction in step 603.

Processing to be performed by the client terminal 110 in an easy scan will be described below.

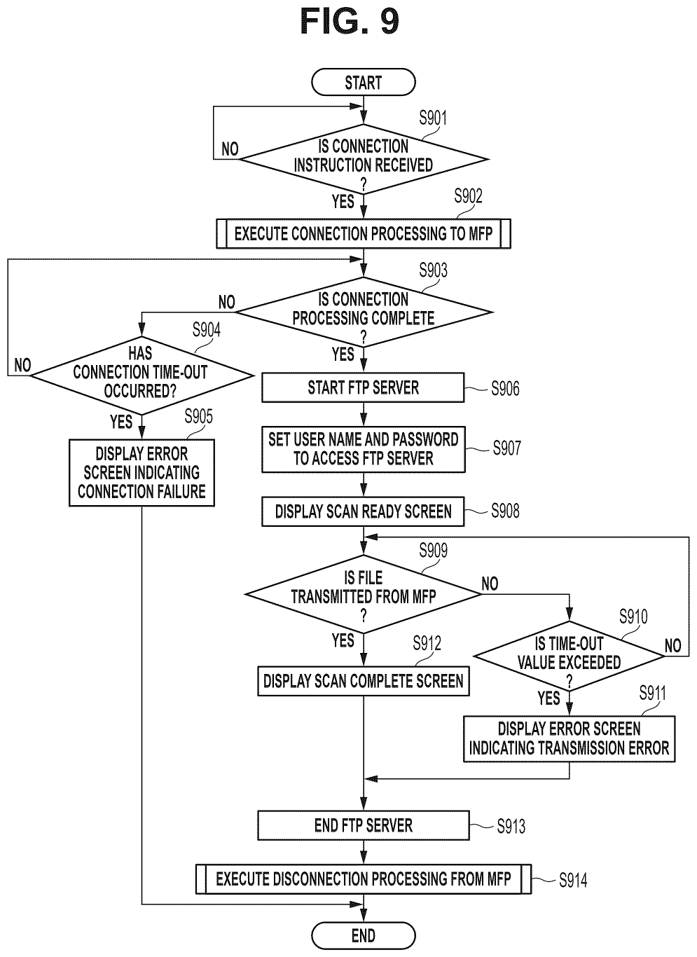

FIG. 9 is a flowchart illustrating an example of processing to be performed by the client terminal 110 (processing to be performed when easy scan processing is executed by the client terminal 110 connected to the MFP 100) in easy scan processing according to the first exemplary embodiment. The processing illustrated in FIG. 9 is executed by a function to be implemented by the CPU 301 loading a program stored in the HDD 306 into the DRAM 302 and executing the program. The processing in the flowchart is started when the user starts the easy scan application 111 on the client terminal 110 and the easy scan application 111 is activated.

In step S901, the client easy scan control unit 505 determines whether an instruction to connect to the MFP 100 is received. Specifically, the client easy scan control unit 505 determines whether the connection button 701 on the connection screen as illustrated in FIG. 7A has been pressed by checking a response from the client operation control unit 501.

If the client easy scan control unit 505 determines that the instruction to connect to the MFP 100 is not received (NO in step S901), the processing of step S901 is repeated.

On the other hand, if the client easy scan control unit 505 determines that the instruction to connect to the MFP 100 is received (YES in step S901), the processing proceeds to step S902.

In step S902, the client easy scan control unit 505 executes connection processing to the MFP 100 via the client network control unit 503. In the connection processing to the MFP 100, the processing performed in the client terminal 110 in steps 604 to 606 illustrated in FIG. 6 is executed, and the connection between the MFP 100 and the client terminal 110 is established.

Next, in step $903, the client easy scan control unit 505 determines whether the connection processing to the MFP 100 is complete. Specifically, the client easy scan control unit 505 determines whether the client network control unit 503 is successfully connected to the MFP 100.

If the client easy scan control unit 505 determines that the connection processing to the MFP 100 is not complete (NO in step S903), the processing proceeds to step S904.

In step S904, the client easy scan control unit 505 determines whether a connection time-out has occurred. A predetermined connection time-out period is set. If the set value is exceeded, it is determined that a connection time-out has occurred. If the set value is not exceeded, it is determined that a connection time-out has not occurred.

If the client easy scan control unit 505 determines that a connection time-out has not occurred (NO in step S904), the processing returns to step S903 and checks again whether the connection processing to the MFP 100 is complete.

On the other hand, if the client easy scan control unit 505 determines that a connection time-out has occurred (YES in step S904), the processing proceeds to step S905.

In step S905, the client network control unit 503 displays an error screen indicating that the connection processing to the MFP 100 is not complete as illustrated in FIG. 7E on the output device of the client terminal 110 using the client operation control unit 501. FIG. 7E illustrates an example of the error screen. In this case, since the connection to the MFP 100 has failed, the error screen is displayed, and then the client network control unit 503 ends the processing in this flowchart.

If the client network control unit 503 determines that the connection processing to the MFP 100 is complete (YES in step S903), the processing proceeds to step S906.

In step S906, the client network control unit 503 starts the FTP server using the client FTP server control unit 504 since the connection processing to the MFP 100 is complete. Thus, the client terminal 110 can exchange data with the MFP 100 using the FTP. While, in the present exemplary embodiment, the FTP is used as the file transfer protocol as described above, the client terminal 110 may communicate with the MFP 100 using another protocol.

Next, in step S907, the client easy scan control unit 505 sets a user name and a password (a user name and a password to permit a connection to the FTP server) that enables access to the FTP server started in step S906 described above. As described in step 610 in FIG. 6, fixed values may be generated or unique values may be generated using a hash function or the like for the user name and the password, as long as the values can be commonly used between the MFP 100 and the client terminal 110. Further, the user name and the password, the IP address of the client terminal 110, and the like may be transmitted to the MFP 100 from the client terminal 110.

Next, in step S908, the client easy scan control unit 505 displays the scan ready screen as illustrated in FIG. 7B on the client terminal 110 using the client operation control unit 501. FIG. 7B illustrates an example of the scan ready screen.

Next, in step S909, the client easy scan control unit 505 checks whether electronic data (file) from the MFP 100 is transmitted to a predetermined directory via the client FTP server control unit 504 and the client data storage unit 502. Specifically, the client FTP server control unit 504 receives the electronic data from the MFP 100 via the client network control unit 503 using the FTP, and stores the electronic data in the predetermined directory using the client data storage unit 502. Further, the client FTP server control unit 504 notifies the client easy scan control unit 505 of completion of reception of the electronic data from the MFP 100. The client easy scan control unit 505 checks whether a complete notification is received from the client FTP server control unit 504 and checks whether electronic data with a predetermined file name is stored in the predetermined directory using the client data storage unit 502. The predetermined file name is a file name unique to the MFP 100 and the client terminal 110 based on a naming rule described in step 615 illustrated in FIG. 6.

If electronic data with the predetermined file name is not stored in the predetermined directory, the client easy scan control unit 505 determines that the electronic data (file) is not transmitted from the MFP 100 (NO in step S909), and the processing proceeds to step S910.

On the other hand, if electronic data with the predetermined file name is stored in the predetermined directory, the client easy scan control unit 505 determines that the electronic data (file) is transmitted from the MFP 100 (YES in step S909), and the processing proceeds to step S912.

In step S910, since electronic data with the predetermined file name is not stored in the predetermined directory, the client easy scan control unit 505 checks whether a prescribed file transfer time-out value is exceeded.

If the client easy scan control unit 505 determines that the time-out value is not exceeded (NO in step S910), the processing returns to step S909 and checks again whether the electronic data transmitted from the MFP 100 is stored in the predetermined directory.

On the other hand, if the client easy scan control unit 505 determines that the time-out value is exceeded (YES in step S910), the processing proceeds to step S911.

In step S911, since the electronic data has not been transmitted from the MFP 100 within a prescribed time, the client easy scan control unit 505 displays a transmission failure error screen using the client operation control unit 501. FIG. 7F illustrates an example of the transmission failure error screen. To end the processing after the transmission failure error screen is displayed, the processing proceeds to step S913. In step S913, the client easy scan control unit 505 performs FTP server end processing.

In step S912, since the electronic data transmitted from the MFP 100 is stored with the predetermined file name in the predetermined directory, the client easy scan control unit 505 displays a scan complete screen as illustrated in FIG. 7C on the output device of the client terminal 110 using the client operation control unit 501. FIG. 7C illustrates an example of the scan complete screen. Since the scan complete screen has been described above in step 618 illustrated in FIG. 6, the detailed description thereof is omitted. The client easy scan control unit 505 displays the scan complete screen, and then the processing proceeds to step S913.

In step S913, the client easy scan control unit 505 ends the FTP server function. Specifically, the client easy scan control unit 505 issues an FTP server end instruction to the client FTP server control unit 504 to stop the FTP server function. After the client easy scan control unit 505 has stopped the FTP server function, the processing proceeds to step S914.

In step S914, the client easy scan control unit 505 executes disconnection processing from the MFP 100 via the client network control unit 503. In the disconnection processing from the MFP 100, the processing performed in the client terminal 110 in steps 620 to 622 illustrated in FIG. 6 is executed, and the connection between the MFP 100 and the client terminal 110 is disconnected. After the processing of step S914, the client easy scan control unit 505 ends the processing in the flowchart.

Processing to be performed by the MFP 100 in an easy scan will be described below.

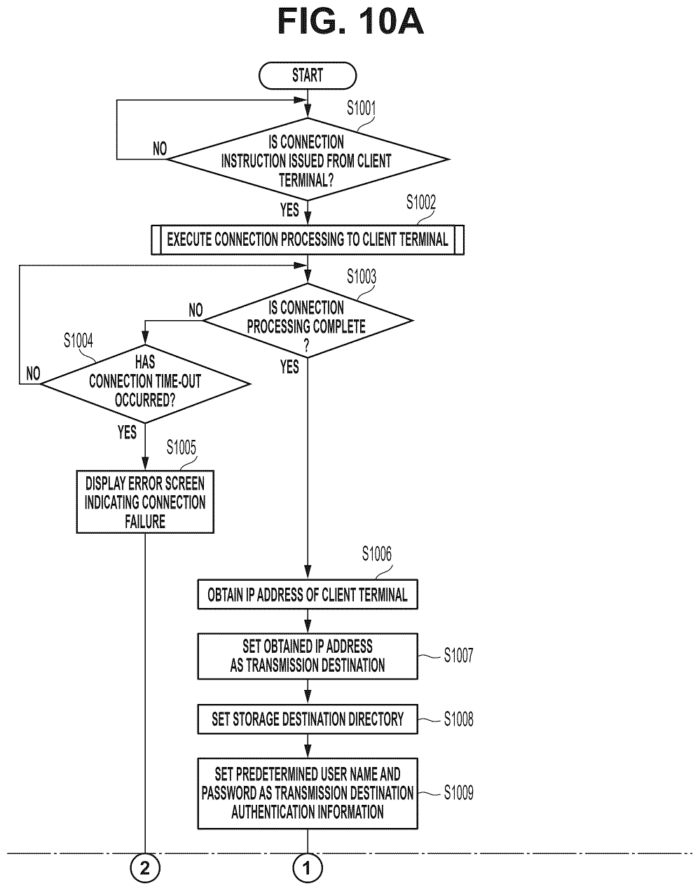

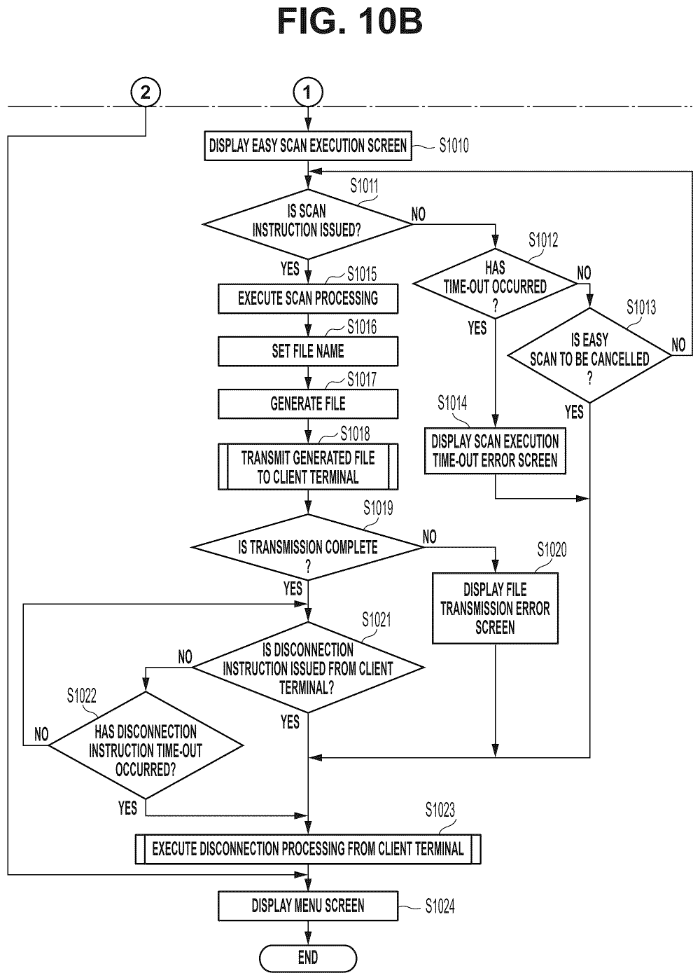

FIGS. 10A and 10B are a flowchart illustrating an example of processing to be performed by the MFP 100 (processing by the MFP 100 from execution of scanning upon reception of an easy scan start instruction from the client terminal 110 to transmission of a file to the client terminal 110) in easy scan processing according to the first exemplary embodiment. The processing illustrated in FIG. 10 is executed by a function to be implemented by the CPU 201 loading a program stored in the flash ROM 210 into the DRAM 202 and executing the program. When the MFP 100 is activated, the processing in the flowchart is started.

In step S1001, the easy scan control unit 409 checks whether a connection instruction is issued from the client terminal 110. Specifically, the easy scan control unit 409 sends an inquiry to the network control unit 407 to check whether a connection request from the client terminal 110 has been received.

If the connection request from the client terminal 110 has not been received (NO in step S1001), the easy scan control unit 409 performs the processing of step S1001 again to check again whether the connection request from the client terminal 110 has been received.

On the other hand, if the connection request from the client terminal 110 has been received (YES in step S1001), the processing proceeds to step S1002.

In step S1002, the easy scan control unit 409 executes connection processing to the client terminal 110 via the network control unit 407. In the connection processing to the client terminal 110, the processing performed in the MFP 100 in steps 604 to 606 illustrated in FIG. 6 is executed, and the connection between the MFP 100 and the client terminal 110 is established.

Next, in step S1003, the easy scan control unit 409 determines whether the connection processing to the client terminal 110 is complete. Specifically, the easy scan control unit 409 checks whether the network control unit 407 is successfully connected to the client terminal 110.

If the easy scan control unit 409 determines that the connection processing to the client terminal 110 is not complete (NO in step S1003), the processing proceeds to step S1004.

In step S1004, the easy scan control unit 409 determines whether a connection time-out has occurred. In this processing, a predetermined connection time-out period is set, and it is determined whether the set value is exceeded.

If the easy scan control unit 409 determines that a connection time-out has not occurred (NO in step S1004), the processing returns to step S1003 and checks again whether the connection processing to the client terminal 110 is complete.

On the other hand, if the easy scan control unit 409 determines that a connection time-out has occurred (YES in step S1004), the processing proceeds to step S1005.

In step S1005, the network control unit 407 displays an error screen as illustrated in FIG. 8C on the operation unit 102 using the operation control unit 401 since the connection processing to the client terminal 110 is not complete. FIG. 8C illustrates an example of the error screen. When an end button 810 on the error screen is pressed, the processing proceeds to step S1024, and the network control unit 407 displays a menu screen (not illustrated) on the MFP 100.

If the easy scan control unit 409 determines that the connection processing to the client terminal 110 is complete (YES in step S1003), the processing proceeds to step S1006.

In step S1006, the easy scan control unit 409 obtains the IP address of the client terminal 110 that has been connected. Specifically, the easy scan control unit 409 sends an inquiry about the IP address of the client terminal 110 connected to the network control unit 407.

Next, in step S1007, the easy scan control unit 409 sets the IP address obtained in step S1006 as a transmission destination of scanned electronic data. Specifically, the easy scan control unit 409 sets the IP address obtained in step S1006 described above as the transmission destination of the FTP.

In step S1008, the easy scan control unit 409 sets a directory that is a storage destination in the client terminal 110 for the scanned electronic data. The storage destination directory is preliminarily determined in the MFP 100 and the client terminal 110. Examples of the storage destination directory include a top directory in the FTP server of the client terminal 110. Instead of transmitting the scanned data to the top directory in the FTP server of the client terminal 110 as described in step 616 illustrated in FIG. 6, a directory for the date when scanning is executed may be generated, and the scanned file may be transmitted to the directory for the date. Alternatively, the scanned data may be transmitted to another directory.

Next, in step S1009, the easy scan control unit 409 sets authentication information for communicating with the client terminal 110 (i.e., information for enabling data transmission to the client terminal 110 as a destination). The authentication information includes a user name and a password. For example, authentication information that is common to the MFP 100 and the client terminal 110 may be used by the method described in step 610 illustrated in FIG. 6, or the like. The easy scan control unit 409 may receive the IP address of the client terminal 110, the user name and the password described above, and the like from the client terminal 110 via the network control unit 407 and may set the received information. In the present exemplary embodiment, since the FTP is used as the file transmission protocol as an example, the user name and the password are used as the authentication information. However, in a case where another protocol is used, different authentication information may be used depending on the protocol.

Next, in step S1010, the easy scan control unit 409 instructs the operation control unit 401 to display the easy scan execution screen as illustrated in FIG. 8A on the operation unit 102. FIG. 8A illustrates an example of the easy scan execution screen.

Next, in step S1011, the easy scan control unit 409 sends an inquiry to the operation control unit 401 to check whether a scan instruction is issued. Specifically, the operation control unit 401 determines whether the scan start button 802 is pressed.

If the easy scan control unit 409 determines that the scan instruction is not issued (NO in step S1011), the processing proceeds to step S1012.

In step S1012, the easy scan control unit 409 checks whether a time-out has occurred after a lapse of a prescribed time without executing scanning. The processing is performed to check whether the user who has established a connection to the MFP 100 has left the MFP 100 unoperated without executing scanning.

If the easy scan control unit 409 determines that a time-out has not occurred (NO in step S1012), the processing proceeds to step S1013.

In step S1013, the easy scan control unit 409 checks with the operation control unit 401 whether the cancel button 804 is pressed.

If the easy scan control unit 409 determines that the cancel button 804 is not pressed (NO in step S1013), the processing returns to step S1011 and checks again whether the scan instruction is issued.

On the other hand, if the easy scan control unit 409 determines that the cancel button 804 is pressed (YES in step S1013), the user has issued an instruction to end the easy scan processing. Accordingly, the processing proceeds to step S1023 to end the processing. In step S1023, the easy scan control unit 409 performs processing for terminating the connection to the client terminal 110.

In step S1012 described above, if the easy scan control unit 409 determines that a time-out has occurred (YES in step S1012), the processing proceeds to step S1014.

In step S1014, the easy scan control unit 409 instructs the operation control unit 401 to display a scan execution time-out error screen as illustrated in FIG. 8D on the operation unit 102.

FIG. 8D illustrates an example of the scan execution time-out error screen. After the processing of step S1014, the processing proceeds to step S1023. In step S1023, the easy scan control unit 409 performs processing for terminating the connection to the client terminal 110.

If the easy scan control unit 409 determines that a scan instruction is issued (YES in step S1011), the processing proceeds to step S1015. In the present exemplary embodiment, for ease of explanation, processing of changing scan-related setting values described in step 612 illustrated in FIG. 6 is not illustrated, which may be executed as follows. Before issuance of the scan execution instruction in step S1011 described above, it may be determined whether the setting change button 803 is pressed, and then change processing for changing the scan-related setting values may be performed.

In step S1015, the easy scan control unit 409 executes scan processing. Specifically, the easy scan control unit 409 issues a scan job to the job control unit 403, and the job control unit 403 scans a document using the scan processing unit 406, thereby generating electronic data. The electronic data generated at this point is unique electronic data dependent on each device and is not data in a format that can be generally handled. In the case of executing scanning using the ADF, in this scan processing, documents set on the ADF are sequentially scanned, and the scan processing is completed when scanning of all the documents set on the ADF ends. In the case of executing scanning of a document placed on a platen glass, in this scan processing, a screen for receiving, from the user, a selection instruction indicating whether to scan the next document or end the scan processing is displayed on the operation unit 102 every time one document is scanned. Then, when an instruction to scan the next document is issued from the user, the document is scanned, and when a scan end instruction is issued from the user, the scan processing is completed. When “double-sided” is set as the scan setting, both sides of the document are scanned. When “image combining” is set as the scan setting, control is performed to execute scan processing a number of times corresponding to the number of images to be combined into one document.

Next, in step S1016, the easy scan control unit 409 generates a file name used to transmit a file to the client terminal 110. As described in step 615 illustrated in FIG. 6, a unique name may be generated based on the date and time when scanning is executed, or a name may be obtained from a result of OCR. While, in the present exemplary embodiment, an example where scanned electronic data is in a multi-page format such as PDF or Tagged Image File Format (TIFF) is described, a single page format such as JPEG may also be used. If a single page format is used, a unique file name may be generated by adding a numerical value indicating a page number to the end of the file name generated by the method described in step 615 illustrated in FIG. 6 described above.

Next, in step S1017, the easy scan control unit 409 generates the file to be transmitted to the client terminal 110 with the file name generated in step S1016 described above based on the setting of the file format in the scan settings 801. Specifically, the job control unit 403 instructs the image processing unit 404 to convert the scanned electronic data into data in a desired image format. Then, the data storage unit 402 stores the electronic data converted into the desired image format in the storage area in the MFP 100.

Next, in step S1018, the easy scan control unit 409 transmits the file generated in step S1017 described above to the client terminal 110. Specifically, the easy scan control unit 409 instructs the network control unit 407 to retrieve the electronic data stored in the data storage unit 402 and communicate with the client terminal 110 via the FTP to thereby transmit the file thereto. In the description of the present exemplary embodiment, FTP negotiation, authentication, and the like are known techniques and are not essential for the present exemplary embodiment, and thus the descriptions thereof are omitted. However, as a matter of course, FTP negotiation, authentication, and the like are performed to transmit the file via the FTP.

Next, in step S1019, the easy scan control unit 409 checks whether transmission of the scanned electronic data to the client terminal 110 is complete. Specifically, the easy scan control unit 409 sends an inquiry to the network control unit 407 to check whether all data in the desired file has been transmitted to the client terminal 110.

If the easy scan control unit 409 determines that the transmission of the data has failed due to a network trouble or the like (NO in step S1019), the processing proceeds to step S1020.

In step S1020, the easy scan control unit 409 displays a file transmission error screen as illustrated in FIG. 8E on the operation unit 102 using the operation control unit 401. FIG. 8E illustrates an example of the file transmission error screen. After the easy scan control unit 409 performs the processing of step S1020, the processing proceeds to step S1023.

If the easy scan control unit 409 determines that the transmission is complete (YES in step S1019), the processing proceeds to step S1021.

In step S1021, the easy scan control unit 409 checks whether a disconnection instruction is issued from the client terminal 110. This processing corresponds to the processing in step S914 illustrated in FIG. 9, in which the disconnection processing from the MFP 100 is executed by the client terminal 110, and it is determined whether the disconnection instruction is issued to the MFP 100. Specifically, the easy scan control unit 409 sends an inquiry to the network control unit 407 to check whether the disconnection instruction is issued from the client terminal 110.

If the easy scan control unit 409 determines that the disconnection instruction is not issued from the client terminal 110 (NO in step S1021), the processing proceeds to step S1022.

In step S1022, the easy scan control unit 409 transmits the scanned electronic data to the client terminal 110 and then checks whether the disconnection instruction has not been issued from the client terminal 110 for a prescribed time and a time-out has occurred.

If the easy scan control unit 409 determines that a time-out has not occurred (NO in step S1022), the processing returns to step S1021 to check again whether the disconnection instruction is issued from the client terminal 110.

On the other hand, if the easy scan control unit 409 determines that a time-out has occurred (YES in step S1022), the processing proceeds to step S1023. In step S1023, the easy scan control unit 409 performs disconnection processing from the client terminal 110.

In step S1021, if the easy scan control unit 409 determines that the disconnection instruction is issued from the client terminal 110 (YES in step S1021), the processing proceeds to step S1023.

In step S1023, the easy scan control unit 409 executes disconnection processing from the client terminal 110 via the network control unit 407. In the disconnection processing from the client terminal 110, the processing performed in the MFP 100 in steps 620 to 622 illustrated in FIG. 6 is executed, and the connection between the MFP 100 and the client terminal 110 is disconnected. In a case where it is determined that a time-out has occurred in step S1022 and the disconnection instruction has not been issued from the client terminal 110, the MFP 100 may forcibly terminate the connection to the client terminal 110. After the easy scan control unit 409 performs the processing of step S1023, the processing proceeds to step S1024.

In step S1024, the easy scan control unit 409 ends the easy scan function and instructs the operation control unit 401, to release the MFP 100 to another user, to display a menu screen (not illustrated) for executing a copy, a fax, and the like on the operation unit 102. After the processing of step S1024, the easy scan control unit 409 temporarily ends the processing of the flowchart, but the easy scan control unit 409 stands by to receive the next request from the client terminal 110 in step S1001 in case the processing of the flowchart is executed again.

The above-described processing enables a user to make settings for transmitting scanned data between the client terminal 110 and the MFP 100 only by the user issuing a scan instruction for the MFP 100 from the client terminal 110 even in an environment in which the user uses the MFP 100 for the first time. This makes it possible to easily execute scanning and transmission of data to the client terminal 110. Therefore, even a general user who simply uses an MFP and does not have technical knowledge about servers, networks, and the like can easily perform push scanning on the PC of the user using an MFP that the user uses for the first time in a coworking space, a shared office, or the like. Consequently, the usability in push scanning to the PC from the MFP can be significantly improved.

While the first exemplary embodiment describes an example where easy scan processing ends after scanning is completed, a second exemplary embodiment describes an example where scan processing can be continuously performed after completion of scanning.

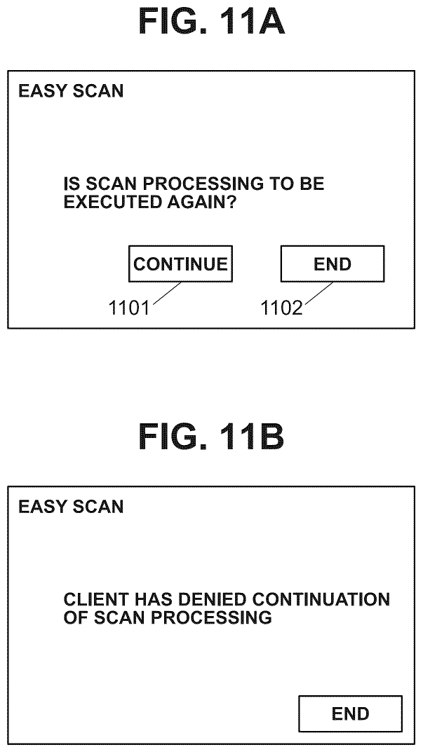

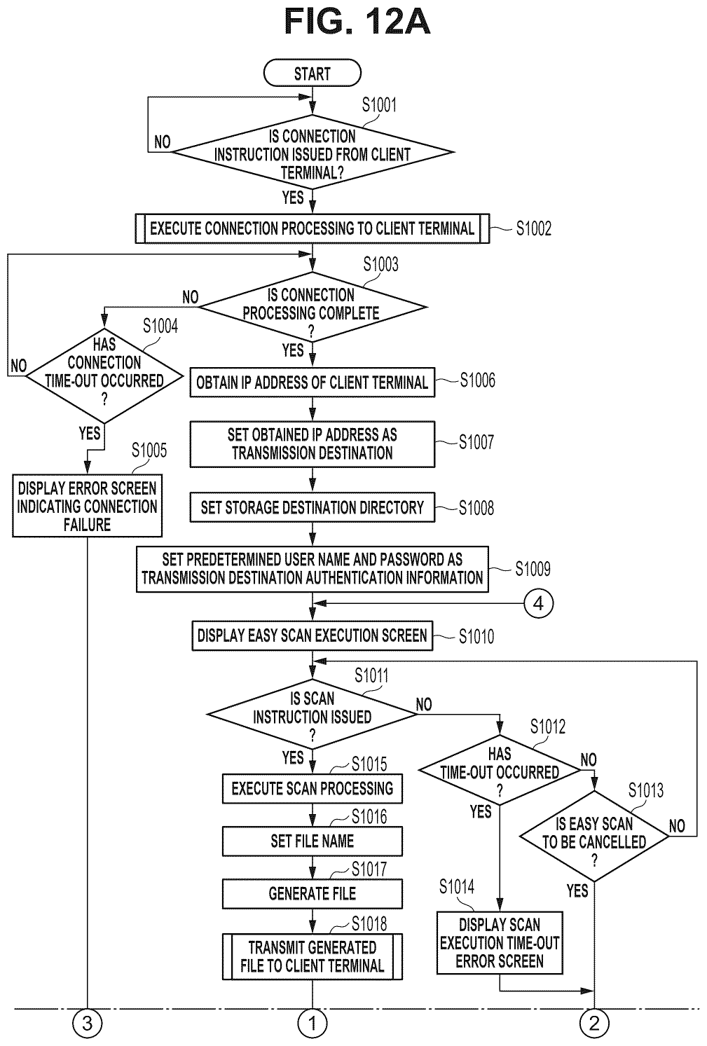

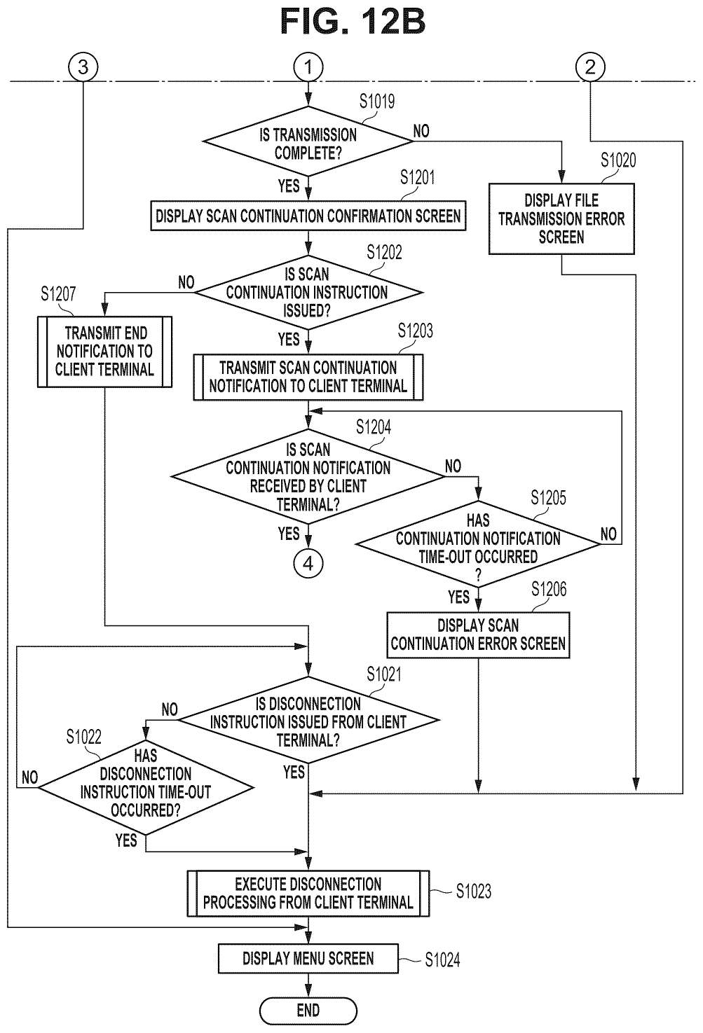

Processing to be performed by a MFP 100 in easy scan processing according to the second exemplary embodiment will be described below with reference to FIGS. 11A and 11B and FIGS. 12A and 12B. Hereinafter, FIGS. 12A and 12B are collectively referred to as “FIG. 12”.

FIGS. 11A and 11B each illustrate an example of a screen to be displayed on the MFP 100 according to the second exemplary embodiment.

FIG. 12 is a flowchart illustrating an example of processing to be performed by the MFP 100 during easy scan processing according to the second exemplary embodiment (processing for enabling continuation of scan processing after confirmation on whether the scan processing is to be continuously performed after completion of scanning). The processing illustrated in FIG. 12 is executed by a function to be implemented by the CPU 201 loading a program stored in the flash ROM 210 into the DRAM 202 and executing the program. The processing in the flowchart is started when the MFP 100 is activated. Steps in FIG. 12 that are identical to those in FIGS. 10A and 10B are denoted by the same step numbers, and descriptions thereof are omitted.

According to the second exemplary embodiment, in step S1019, if the easy scan control unit 409 determines that transmission of the scanned electronic data to the client terminal 110 is complete (YES in step S1019), the processing proceeds to step S1201.

In step S1201, the easy scan control unit 409 instructs the operation control unit 401 to display a scan continuation confirmation screen as illustrated in FIG. 11A on the operation unit 102. FIG. 11A illustrates an example of the scan continuation confirmation screen. The scan continuation confirmation screen includes a scan continuation button 1101 for continuing scan processing and an end button 1102 for ending the scan processing.

Next, in step S1202, the easy scan control unit 409 determines whether a scan continuation instruction is issued on the scan continuation confirmation screen displayed in step S1201 described above. Specifically, the easy scan control unit 409 checks whether the scan continuation button 1101 is pressed or the end button 1102 is pressed using the operation control unit 401. For example, if the user wants to continuously perform scanning of another document, the user sets the document to be scanned on the ADF or the like of the MFP 100, and presses the scan continuation button 1101.

If the easy scan control unit 409 determines that the scan continuation button 1101 is pressed to continue the scan processing (YES in step S1202), the processing proceeds to step S1203.

In step S1203, the easy scan control unit 409 transmits a scan continuation notification to the client terminal 110 using the network control unit 407. Any notification method may be used as long as the scan continuation notification can be transmitted from the MFP 100 to the client terminal 110. For example, a specific folder for receiving the notification from the MFP 100 may be prepared in the client terminal 110. A configuration may be such that, as a file indicating continuation of scanning, a file with a file name “continue.txt” may be transmitted to the client terminal 110 from the MFP 100 via the FTP to notify the client terminal 110 that scanning is to be continued. Confirming whether to continue scanning by file transmission is merely an example, and another configuration may be used as long as the scan continuation notification can be implemented between the MFP 100 and the client terminal 110.

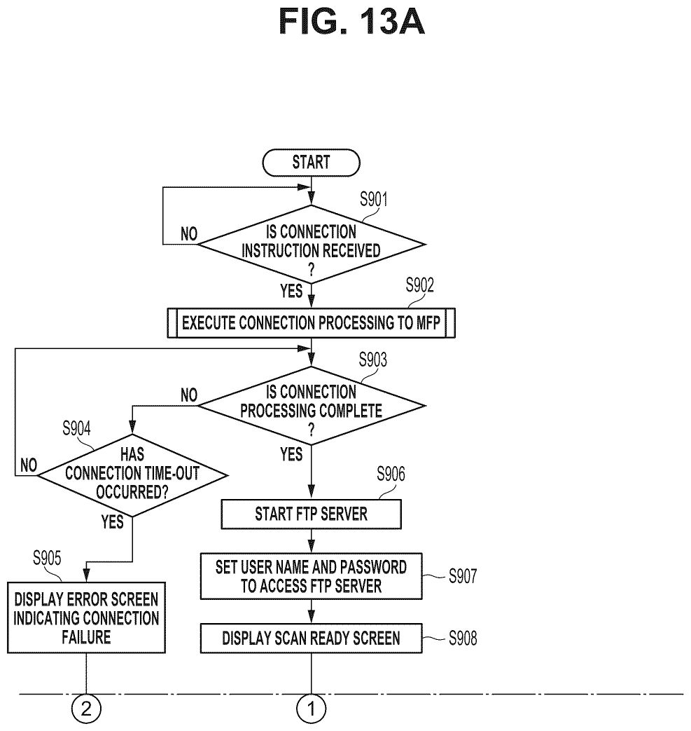

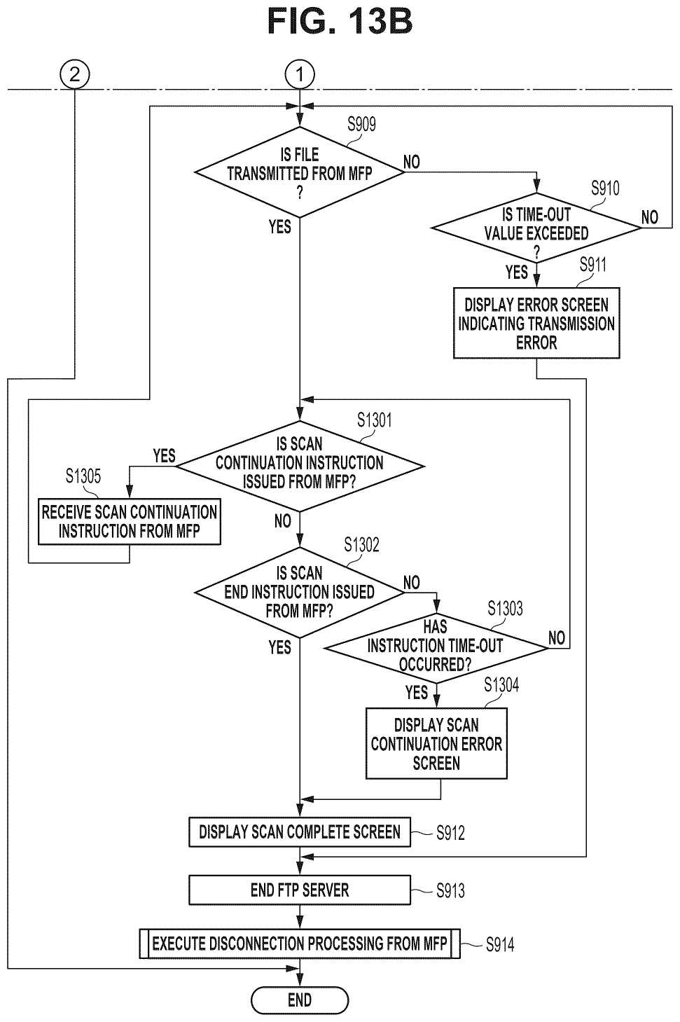

Next, in step S1204, the easy scan control unit 409 determines whether the client terminal 110 has received the scan continuation instruction from the MFP 100. Specifically, the easy scan control unit 409 checks whether the client terminal 110 has received the scan continuation instruction, using the network control unit 407. For example, in the case of transmitting the file indicating continuation of scanning to the client terminal 110 from the MFP 100 as described above, the client terminal 110 may delete the file indicating continuation of scanning upon reception of the scan continuation instruction (step S1305 in FIG. 13B to be described below). The easy scan control unit 409 checks the specific folder for receiving the notification from the MFP 100 of the client terminal 110 described above via the network control unit 407. Then, if the folder does not include the file that indicates continuation of scanning that is transmitted in step S1203 described above, it is determined that the client terminal 110 has received the scan continuation instruction from the MFP 100. On the other hand, if the folder includes the file that indicates continuation of scanning that is transmitted in step S1203 described above, it is determined that the client terminal 110 has not received the scan continuation instruction from the MFP 100. Alternatively, instead of deleting the file indicating the scan continuation instruction by the client terminal 110, the following method may be employed. A file name indicating the scan continuation instruction is changed to, for example, “continue_OK.txt” by the client terminal 110. Subsequently, if the MFP 100 finds the changed file name, it is determined that the scan continuation instruction is received, and then the file is deleted. On the other hand, if the MFP 100 does not find the changed file name, it is determined that the scan continuation instruction is not received.

If the easy scan control unit 409 determines that the client terminal 110 has received the scan continuation instruction (YES in step S1204), the processing proceeds to step S1010. In step S1010, the easy scan control unit 409 displays the easy scan execution screen again and waits for the next scan instruction.

On the other hand, if the easy scan control unit 409 determines that the client terminal 110 has not received the scan continuation instruction (NO in step S1204), the processing proceeds to step S1205.

In step S1205, the easy scan control unit 409 transmits a scan continuation notification to the client terminal 110 and then checks whether a time-out has occurred because the easy scan control unit 409 cannot confirm reception of the scan continuation notification from the client terminal 110 for a prescribed time.

If the easy scan control unit 409 determines that a time-out has not occurred (NO in step S1205), the processing returns to step S1204 to check again whether the client terminal 110 has received the scan continuation instruction.

On the other hand, if the easy scan control unit 409 determines that a time-out has occurred (YES in step S1205), the processing proceeds to step S1206.

In step S1206, the easy scan control unit 409 displays a scan continuation error screen as illustrated in FIG. 11B on the operation unit 102 using the operation control unit 401. FIG. 11B illustrates an example of the scan continuation error screen. In this case, because continuation of scanning is not possible, the processing proceeds to step S1023. In step S1023, the easy scan control unit 409 performs disconnection processing from the client terminal 110.

If the easy scan control unit 409 determines that the end button 1102 is pressed to end the scan processing (NO in step S1202), the processing proceeds to step S1207.

In step S1207, the easy scan control unit 409 transmits a scan end instruction to the client terminal 110 using the network control unit 407 since the user has issued an instruction to end the scan processing. Any transmission method may be used as long as a notification to end the scan processing can be transmitted to the client terminal 110 from the MFP 100. For example, a specific folder for receiving the notification from the MFP 100 may be prepared in the client terminal 110. A configuration may be such that, as a file indicating the end of scanning, a file with a name “complete.txt”, for example, may be transmitted to the client terminal 110 from the MFP 100 via the FTP to notify the end of scanning. Transmitting the scan end notification by file transmission is merely an example, and any method may be used as long as the scan end notification can be implemented between the MFP 100 and the client terminal 110.

After the processing of step S1207, the processing proceeds to step S1021, and the easy scan control unit 409 waits for a disconnection instruction from the client terminal 110. Unlike the scan continuation instruction, the disconnection instruction is transmitted to the MFP 100 from the client terminal 110 in the case of the scan end notification. Accordingly, processing of checking whether the client terminal 110 has received the scan end notification is omitted.

In step S1205, if the time-out has occurred (YES in step S1205), as in step S1207, the scan end instruction may be transmitted to the client terminal 110, and then the processing may proceed to step S1021.

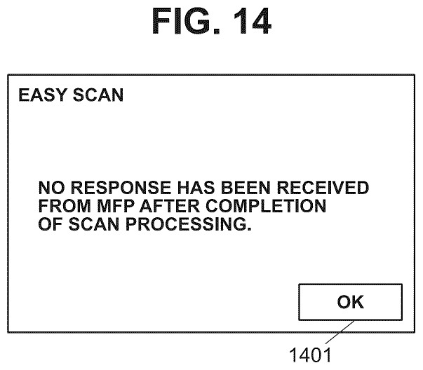

Processing to be performed by the client terminal 110 in the easy scan processing according to the second exemplary embodiment will be described below with reference to FIGS. 13A and 13B and FIG. 14.

FIGS. 13A and 13B are a flowchart illustrating an example of processing to be performed by the client terminal 110 during the easy scan processing according to the second exemplary embodiment (processing for enabling continuation of scan processing after confirmation on whether the scan processing is to be continuously performed after completion of scanning). The processing illustrated in FIGS. 13A and 13B is executed by a function to be implemented by the CPU 301 loading a program stored in the HDD 306 into the DRAM 302 and executing the program. The processing in the flowchart is started when the user starts the easy scan application 111 on the client terminal 110 and the easy scan application 111 is activated. Steps in FIGS. 13A and 13B that are identical to those in FIG. 9 are denoted by the same step numbers, and descriptions thereof are omitted.

FIG. 14 illustrates an example of a screen to be displayed on the client terminal 110 according to the second exemplary embodiment.

According to the second exemplary embodiment, in step S909, if the client easy scan control unit 505 determines that electronic data (file) is transmitted from the MFP 100 (YES in step S909), the processing proceeds to step S1301.

In step S1301, the client easy scan control unit 505 checks whether a scan continuation instruction is issued from the MFP 100. The scan continuation instruction may be issued by any method as long as the scan continuation notification can be transmitted to the client terminal 110 from the MFP 100. For example, a specific folder for receiving the notification from the MFP 100 is prepared, as in step S1203 illustrated in FIG. 12. The scan continuation notification is transmitted by transmitting, for example, a file with a name “continue.txt” to the folder in the client terminal 110 from the MFP 100 via the FTP as a file indicating continuation of scanning. Then, the client easy scan control unit 505 determines whether the scan continuation instruction is issued from the MFP 100 using the client FTP server control unit 504 based on whether the specific folder for receiving the notification from the MFP 100 includes the file indicating the scan continuation notification.

If the client easy scan control unit 505 determines that the scan continuation instruction is issued (YES in step S1301), the processing proceeds to step S1305.

In step S1305, since the scan continuation instruction is issued, the client easy scan control unit 505 performs reception processing to indicate that the scan continuation instruction is received from the MFP 100. For example, assume that a file with a name “continue.txt” is placed as the file indicating continuation of scanning from the MFP 100, as in step S1203 illustrated in FIG. 12. The file with the name “continue.txt” is deleted to indicate that the scan continuation instruction is received. As in step S1204 illustrated in FIG. 12, the MFP 100 determines that the scan continuation instruction is received by the client terminal 110 by confirming that the file (continue.txt) indicating the scan continuation instruction is not present.

After the processing of step S1305 described above, the processing returns to step S909, and the client easy scan control unit 505 waits for transmission of the next scanned data from the MFP 100. Instead of deleting the file to indicate that the scan continuation instruction is received, another configuration may be used as long as it is possible for the MFP 100 and the client terminal 110 to recognize that the scan continuation instruction is received. For example, the client terminal 110 may change the name of the file to, for example, “continue_OK.txt”, and the file name changed by the MFP 100 may be detected to thereby notify that the scan continuation instruction is received.

In step S1301, if the client easy scan control unit 505 determines that the scan continuation instruction is not issued (NO in step S1301), the processing proceeds to step S1302.

In step S1302, the client easy scan control unit 505 checks whether the scan end instruction is issued from the MFP 100. Any method may be used as long as the scan end notification can be transmitted from the MFP 100 to the client terminal 110. For example, a specific folder for receiving the notification from the MFP 100 may be prepared, as in step S1207. Further, for example, a file with a name “complete.txt” may be transmitted to the folder in the client terminal 110 from the MFP 100 via the FTP as the file indicating the end of scanning, thereby the end of scanning is notified. Then, the client easy scan control unit 505 determines whether the scan end instruction is issued from the MFP 100 using the client FTP server control unit 504 based on whether the specific folder for receiving the notification from the MFP 100 includes the file indicating the scan end notification.

If the client easy scan control unit 505 determines that the scan end instruction is issued (YES in step S1302), the processing proceeds to step S912. Then, the scan complete screen is displayed, and easy scan processing ends (steps S913 and S914).

On the other hand, if the client easy scan control unit 505 determines that the scan end instruction is not issued (NO in step S1302), the processing proceeds to step S1303.

In step S1303, the client easy scan control unit 505 checks whether a time-out has occurred because the client easy scan control unit 505 cannot confirm reception of the scan continuation notification or the scan end notification from the MFP 100 for a prescribed time (checks whether a prescribed time has elapsed without receiving the scan end notification).

If the client easy scan control unit 505 determines that a time-out has not occurred (NO in step S1303), the processing returns to step S1301 to check again whether the scan continuation instruction is issued from the MFP 100.

On the other hand, if the client easy scan control unit 505 determines that a time-out has occurred (YES in step S1303), the processing proceeds to step S1304.

In step S1304, the client easy scan control unit 505 displays a client scan continuation error screen as illustrated in FIG. 14 on the output device of the client terminal 110 using the client operation control unit 501. FIG. 14 illustrates an example of the client scan continuation error screen. In this case, the issuance of the scan continuation instruction from the MFP 100 is not confirmed. Accordingly, when an OK button 1401 is pressed on the client scan continuation error screen, the processing proceeds to step S912, and the client easy scan control unit 505 displays a scan complete screen to present scanned data to the user and then ends the easy scan processing (steps S913 and S914).

The above-described processing makes it possible to continuously execute scan processing after completion of scanning, in addition to the effect of the first exemplary embodiment.

The configurations and contents of various data described above are not limited to those described above, and the various data may be configured with various configurations and contents according to the use application and purpose.

While the present disclosure has described exemplary embodiments, some embodiments can be implemented as a system, an apparatus, a method, a program, a storage medium, or the like. Some embodiments may be applied to a system constituted of a plurality of devices or may be applied to an apparatus constituted of a single device.

According to the present exemplary embodiment, it is possible for a user to easily receive scanned data obtained by scanning a document using an image processing apparatus on an information processing apparatus of the user even in an environment in which the user uses the image processing apparatus for the first time. Consequently, even a general user who does not have technical knowledge about servers, networks, and the like can easily perform push scanning on an information processing apparatus such as a PC from an image processing apparatus that the user uses for the first time in a coworking space, a shared office, or the like.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-081634, which was filed on May 20, 2024 and which is hereby incorporated by reference herein in its entirety.

What is claimed is:

1. An information processing apparatus, comprising:
one or more memories storing instructions; and
one or more processors capable of executing the instructions causing the information processing apparatus to:
establish a communication connection to an image processing apparatus located in proximity to the information processing apparatus;
activate a function for receiving scanned data from the image processing apparatus upon establishment of the communication connection to the image processing apparatus; and
receive scanned data obtained by scanning a document on the image processing apparatus from the image processing apparatus using the function.

2. The information processing apparatus according to claim 1,
wherein the instructions further cause the information processing apparatus to transmit, to the image processing apparatus, information for enabling data transmission to the information processing apparatus as a destination, and
wherein the scanned data transmitted from the image processing apparatus is received using the transmitted information.

3. The information processing apparatus according to claim 2,
wherein, as activation of the function, a server configured to receive scanned data from the image processing apparatus is started, and a user name and a password are set in the server to permit a connection to the server, and
wherein the transmitted information includes the user name and the password.

4. The information processing apparatus according to claim 3, wherein the scanned data from the image processing apparatus is received via the server using the user name and the password.

5. The information processing apparatus according to claim 1, wherein, in the communication connection, the information processing apparatus and the image processing apparatus are directly connected via wireless communication.

6. The information processing apparatus according to claim 1, wherein the instructions further cause the information processing apparatus to deactivate the function and disconnect the communication connection in a case where reception of the scanned data is complete.

7. The information processing apparatus according to claim 1, wherein the instructions further cause the information processing apparatus to deactivate the function and disconnect the communication connection in a case where an instruction to end scanning is received from the image processing apparatus.

8. A method for an information processing apparatus, the method comprising:
establishing a communication connection to an image processing apparatus located in proximity to the information processing apparatus;
activating a function for receiving scanned data from the image processing apparatus upon establishment of the communication connection to the image processing apparatus; and
receiving scanned data obtained by scanning a document on the image processing apparatus from the image processing apparatus using the function.

9. A non-transitory computer-readable storage medium on which computer-executable instructions are stored for causing a computer to execute a method for an information processing apparatus, the method comprising:
establishing a communication connection to an image processing apparatus located in proximity to the information processing apparatus;
activating a function for receiving scanned data from the image processing apparatus upon establishment of the communication connection to the image processing apparatus; and
receiving scanned data obtained by scanning a document on the image processing apparatus from the image processing apparatus using the function.
